(19) United States
(12) Patent Application Publication
(10) Pub. No.: US 2009/0319395 A1
(43) Pub. Date: Dec. 24, 2009

(54) METHOD OF SELLING AND SHIPPING A PRODUCT UTILIZING THE INTERNET

(75) Inventor: Kapoor Chandaria, Nairobi (KE)

Correspondence Address: SAND & SEBOLT, AEGIS TOWER, SUITE 1100, 4940 MUNSON STREET, NW, CANTON, OH, 44718-3615, US

(73) Assignee: KITARU INNOVATIONS INC., Lascelles (BB)

(21) Appl. No.: 12/551,659

(22) Filed: Sep. 1, 2009

Related U.S. Application Data
(63) Continuation-in-part of application No. 11/955,519, filed on Dec. 13, 2007, now Pat. No. 7,614,992.

(51) Int. Cl. G06Q 30/00; G06F 3/048; G06Q 99/00

(52) U.S. Cl. 705/26; 715/760; 705/1

(57) ABSTRACT

A business method includes listing a product for sale on an online auction site, ordering packaging via a link on the online auction site for shipping the product to a buyer with a winning bid, where the packaging is in the form of a collapsed box mailed to the seller at a non-flat rate of postage and then mailed by the seller to the buyer at a flat rate of postage. The box when in both the collapsed state and the filled state is of substantially the same height as one of the side panels and is able to fit inside a standard size mailbag of a mail carrier.

### CROSS-REFERENCE TO RELATED APPLICATIONS

This is a Continuation-in-Part of U.S. patent application Ser. No. 11/955,519, filed Dec. 13, 2007, the entire specification of which is incorporated herein by reference.

### BACKGROUND OF THE INVENTION

1. Technical Field

The invention relates generally to a business method for selling and shipping products utilizing the internet. Specifically, the business method includes listing a product for sale on an online auction site, ordering packaging via a link on the online auction site for shipping the product to a buyer with a winning bid where the packaging is in the form of a collapsed box mailed to the seller at a non-flat rate of postage and then mailed by the seller to the buyer at a flat rate of postage. The box when in both the collapsed state and the filled state is of substantially the same height as one of the side panels and is able to fit inside a standard size mailbag of a mail carrier.

2. Background Information

In recent years there has been a tremendous increase in e-commerce, the marketing and sales of goods over the Internet. Some of the most popular e-commerce sites are online auction sites such as eBay®. These sites generally work in the following way. The seller creates an online listing with the online auction site for a product they wish to sell. Potential buyers view this online listing and submit online bids for the product. After a predetermined period of time, the bidding is closed and the highest bid wins the auction. The potential buyer with the highest bid is contacted by the online auction site. They are advised that they have won the auction and are told how to pay the seller directly. The buyer then transfers payment to the seller and advises the seller of their mailing address. The seller boxes up the auctioned product and sends it to the buyer through the mail.

This type of transaction has produced at least two issues for the seller. Firstly, they need to find suitable packaging to send the auctioned product to the buyer through the mail. Secondly, the seller needs to advise the buyer of the costs involved for shipping the auctioned product to them. In some countries, such as the United States, it is fairly simple for the seller to calculate the cost of shipping as all that is necessary to determine this cost are the dimensions of the package to be shipped and the weight of the same. In other countries, however, such as in Canada, the seller also needs to know the address of the potential buyer as shipping costs in Canada are calculated based on the dimension of the package being shipped, the weight of the package and the address to which the package has to be shipped. As the seller does not know who is ultimately going to win the auction, it is essentially impossible for them to include accurate shipping estimates for potential buyers to review before they bid on a product. This uncertainty has resulted in a substantially lower sell rate in the online auction business in countries such as Canada as compared to sell rates in the United States.

Yet another issue that affects this type of business which exists in several countries such as Canada, the United Kingdom and Australia is that most of the mail delivered in those countries is delivered by mail carriers who walk their routes carrying mailbags. In Canada, for example, mail carriers are not permitted to carry any mail that does not fit inside a standard size mailbag that is typically utilized by mail carriers.

There is therefore a need in the art for an improved method of selling and shipping products utilizing the internet that addresses these issues.

### BRIEF SUMMARY OF THE INVENTION

A business method is disclosed that includes listing a product for sale on an online auction site, ordering packaging via a link on the online auction site for shipping the product to a buyer with a winning bid, where the packaging is in the form of a collapsed box mailed to the seller at a non-flat rate of postage and then mailed by the seller to the buyer at a flat rate of postage. The box when in both the collapsed state and the filled state is of substantially the same height as one of the side panels and is able to fit inside a standard size mailbag of a mail carrier.

In a first instance, the method of selling and shipping a product utilizing the internet comprises the steps of:

a) providing an online auction site on the internet;

b) receiving an online listing for a product from a seller;

c) offering the seller an opportunity to purchase a flat-rate box for subsequent shipping of the product;

d) determining the starting bid for the product;

e) posting an auction listing for the product on the auction site, which listing incorporates the starting bid;

f) receiving a plurality of bids for the product from a plurality of potential buyers over a predetermined period of time;

g) determining the highest bid from the plurality of bids when the period of time has elapsed;

h) determining a shipping cost for shipping the product;

i) determining the amount of money to be paid to the seller by the buyer who made the highest bid;

j) contacting the buyer with the highest bid to advise them that they have won the auction for the product; and

k) advising the buyer with the highest bid of the amount of money to be paid directly to the seller.

The method further includes the steps of shipping the ordered flat-rate box to the seller at a non-flat rate. Furthermore, the box is shipped in a collapsed state where the height of the box is substantially the same as the height of one of the panels excluding the top and bottom flaps that extend outwardly away therefrom.

In a second instance, the method of shipping and selling a product utilizing the internet includes the steps of:

providing an online auction site where a seller is able to create an auction listing offering a product for sale and potential buyers are able to view that auction listing and submit bids for purchase of the product;

offering a plurality of different size boxes for a seller to purchase in order to mail an auctioned product to a potential buyer, receiving an online listing for a product from a seller including a starting price;

receiving an order for a particular size box from the seller;

determining a starting bid for the product by adding a price for purchasing and shipping the particular size box to a starting price selected by the seller;

posting the auction listing for the product including the starting bid;

receiving a plurality of bids from potential buyers over a predetermined period of time;

determining the highest bid from a plurality of bids after the period of time has elapsed;

contacting the potential buyer with the highest bid to advise them that they have won the auction for the product;

advising the buyer with the highest bid as to how to pay the seller directly; and

shipping the particular size box to the seller in a collapsed condition, where the box has a maximum height substantially equal to a height of one of a plurality of side panels as measured between a top and a bottom edge of the panel.

In a third instance, the method of selling and shipping a product utilizing the internet comprises the steps of:
creating an online listing for a product on an online auction site;
ordering a collapsed flat-rate box from a packaging supplier via an online link on the online auction site;
receiving the collapsed flat-rate box from the packaging supplier;
receiving notification of a winning bid from the online auction site;
receiving payment for the product from a buyer who made the winning bid;
erecting the collapsed box;
loading the product into the erected box;
sealing the loaded box;
placing a mailing address for the buyer on the box; and
sending the loaded flat-rate box to the buyer through the mail.
   In each embodiment of the invention, the method includes utilizing boxes that are of dimensions suitable for carrying within a standard size mailbag of a mail carrier whether the box is collapsed or erected. This is of importance because the box can travel through the regular mail service instead of requiring special handling as a parcel or requiring the use of a courier type service. The use of this box reduces the overall costs of shipping the box itself to the seller and subsequently shipping the product to the buyer. Furthermore, the method includes using a box that is mailed at a flat rate of postage to the buyer. This permits the seller to predict the shipping costs with certainty and thereby removes one of the blockages to making sales.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of the box of the present invention;

FIG. 1A is a plan view of a blank used to form the box of the present invention and showing the exterior surface thereof;

FIG. 1B is a plan view of the blank of FIG. 1A showing the interior surface thereof;

FIG. 1 C is a plan view of an alternative blank used to form the box of the present invention and showing the exterior surface thereof;

FIG. 2 is a perspective view of the box shown in FIG. 1 in a collapsed configuration;

FIG. 3 is a perspective view of the box shown in FIG. 1 with the flaps moved to a second position;

FIG. 4 is a perspective view of the box shown in FIG. 1 in a first collapsed position with the flaps collapsed against the body;

FIG. 5 is a perspective view of the box shown in FIG. 1, with the box rotated into a second collapsed position where the flaps are retained against the body;

FIG. 6 is a perspective view of the box shown in FIG. 5 with a printer acting thereon;

FIG. 6A is a perspective view of a plurality of boxes banded together for shipping;

FIG. 7 is a perspective view of the box shown in FIG. 6 moved back to the first collapsed position shown in FIG. 4 for opening;

FIG. 8 is a perspective view of the box shown in FIG. 6 with the bottom set of flaps moved to the open position;

FIG. 9 is a perspective view of the box shown partially constructed;

FIG. 10 is a perspective view of the box of FIG. 1 shown with the bottom of the box more fully constructed;

FIG. 11 is a perspective view of the box shown in FIG. 1 fully constructed and with the top flaps in the retained position;

FIG. 12 is a perspective view of the box shown in FIG. 1 with the top flaps moving towards a closed position;

FIG. 13 is a flow chart illustrating a first method of selling and shipping a product utilizing the internet in accordance with the present invention;

FIG. 14 is a flow chart illustrating a method of calculating shipping costs use in the method of selling and shipping a product shown in FIG. 13;

FIG. 15 is a flow chart illustrating a second method of selling and shipping a product utilizing the internet in accordance with the present invention; and

FIG. 16 is a flow chart illustrating a third method of selling and shipping a product utilizing the internet in accordance with the present invention.

Similar numbers refer to similar parts throughout the drawings.

### DETAILED DESCRIPTION OF THE INVENTION

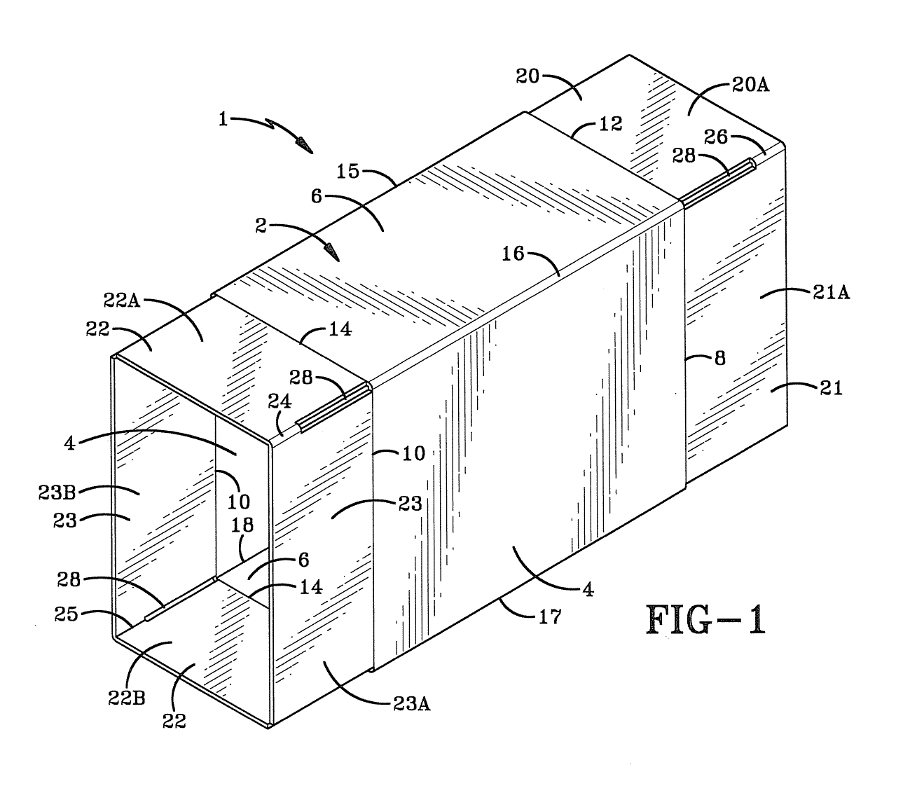

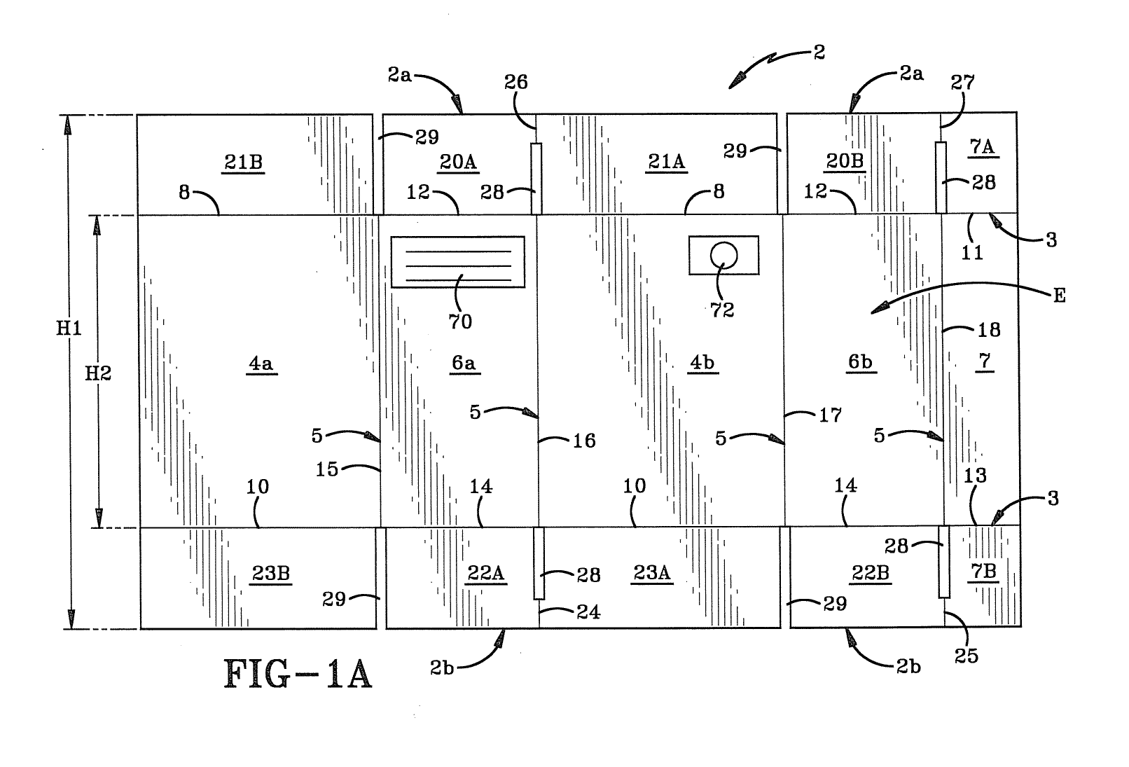

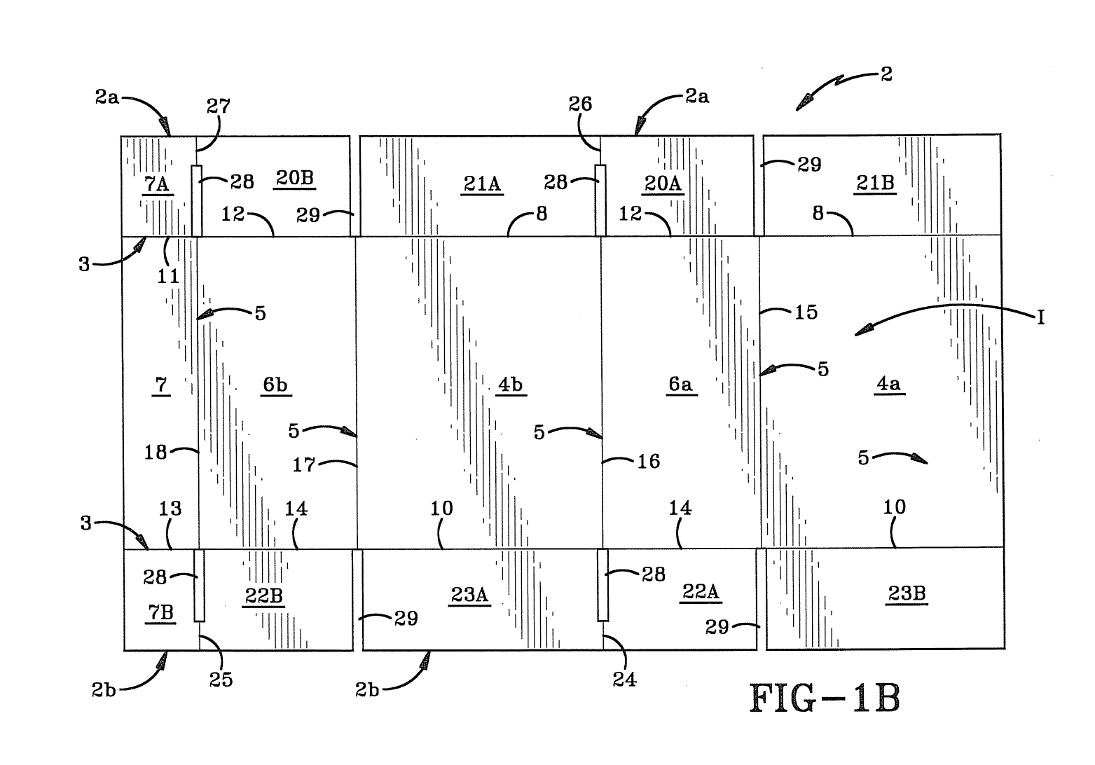

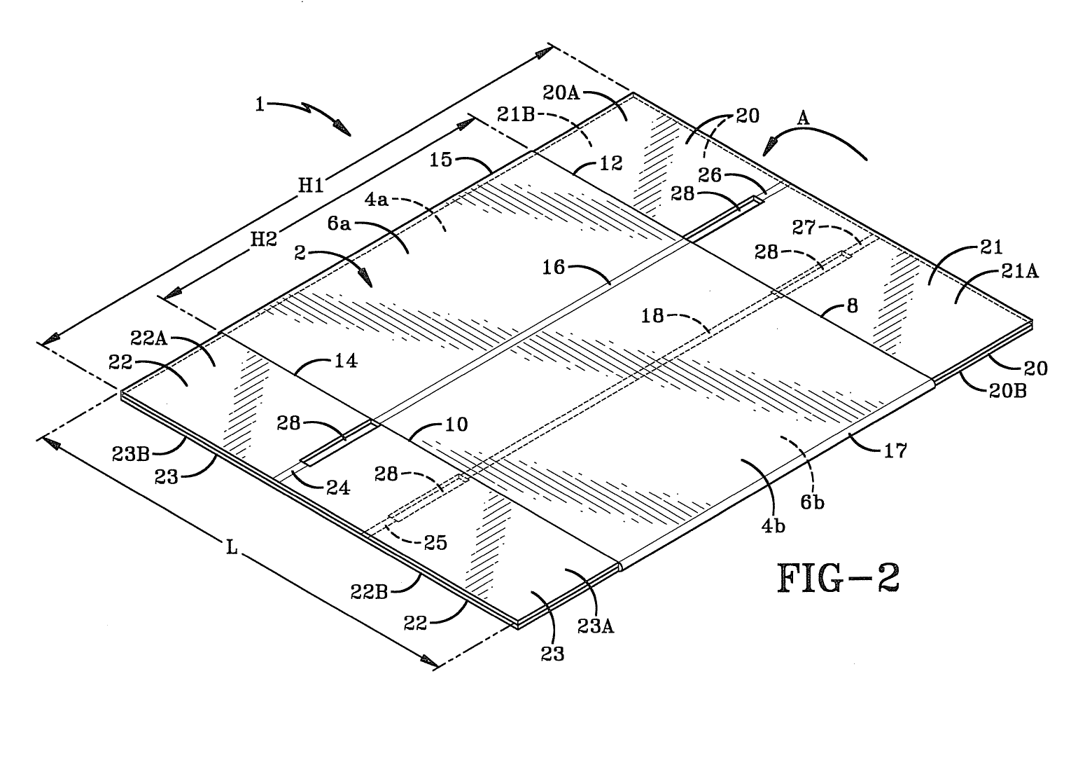

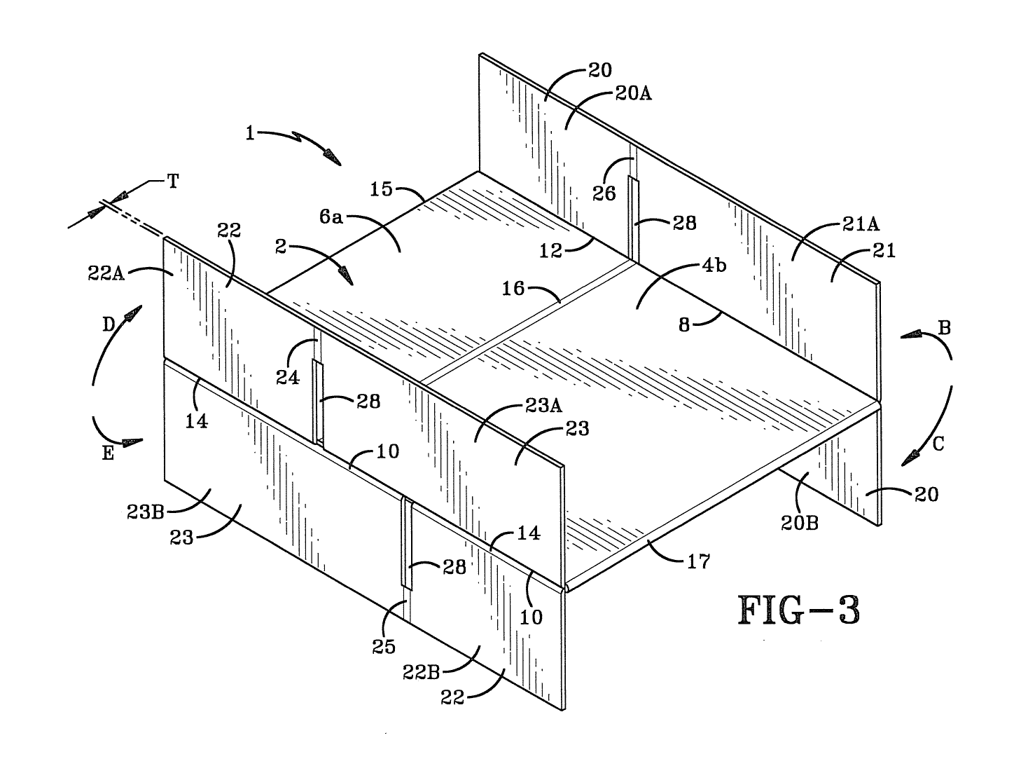

The storage and shipping box of the present invention is indicated generally at the numeral 1, and is shown specifically in FIGS. 1-12. FIGS. 1A and 1B show a blank 2 that is used to construct the box 1. Blank 2 is a planar sheet of material that preferably is of a uniform thickness “T” (FIG. 3). FIG. 1A shows the exterior surface “E” of blank 2 and FIG. 1B shows the interior surface “I” of blank 2. As is well-known in the art, blank 2 may be made of a variety of materials including corrugated cardboard, non-corrugated paperboard, or a variety of wax-coated products including paper and plastic.

In accordance with a specific feature of the present invention, blank 2 includes a plurality of foldlines that are used to erect box 1. Blank 2 preferably is provided with two horizontally oriented and spaced-apart foldlines 3 and four vertically oriented and spaced-apart foldlines 5. It will be understood, however, that other arrangements and numbers of foldlines 3, 5 may be provided to construct boxes of different shapes to that shown in FIG. 1. Foldlines 5 divide blank 2 into a first panel 4a, a second panel 6a, a third panel 4b, a fourth panel 6b, and a connector panel 7. Foldlines 3 form a top edge and bottom edge for each of the panels 4a through 6b and separate them from a top flap and a bottom flap, respectively. First panel 4a has a top edge 8 with a top flap 21B extending outwardly away therefrom and a bottom edge 10 with a bottom flap 22B extending outwardly away therefrom. It will be understood that top and bottom edges 8, 10 are disposed along the spaced apart foldlines 3. It should further be understood that top and bottom flaps 21B, 22B are substantially coplanar with first panel 4a before the construction of box 1 is initiated.

Second panel 6a has a top edge 12 with a top flap 20A extending outwardly away therefrom and a bottom edge 14 with a bottom flap 22A extending outwardly away therefrom. Top and bottom edges 12, 14 are disposed along foldlines 3 and top and bottom flaps 20A, 22A are substantially coplanar with second panel 6a. First panel 4a is separated from second panel 6a by a joint 15 that is disposed along one of foldlines 5. It should be noted that a gap 29 exists between top flaps 21B and 20A and between bottom flaps 22B and 22A. These gaps 29 extend substantially from the foldlines 3 to the respective outermost edges 2a or 2b of blank 2.

Third panel 4b has a top edge 8 with a top flap 21A extending outwardly away therefrom, and a bottom edge 10 with a bottom flap 23A extending outwardly away therefrom. Once again, top and bottom edges 8, 10 are disposed along the spaced apart foldlines 3 and top and bottom flaps 21AB, 23A are substantially coplanar with third panel 4b. Third panel 4b is separated from second panel 6a by A joint 16 that falls on another of foldlines 5. In accordance with a specific feature of the present invention, top flaps 20A, 21A are partially separated from each other by a gap 28 while a hinge 26 connects a portion of the top flaps 20A, 21A together. Hinge 26 originates a distance outwardly away from foldline 3 and continues to the outermost edge 2a of blank 2. Similarly, a portion of bottom flap 22A is separated from a portion of bottom flap 23A by a gap 28 while a hinge 24 connects another portion of flaps 22A, 23A together. Hinge 24 originates a distance outwardly away from foldline 3 and continues to outermost edge 2b of blank 2.

Fourth panel 6b has a top edge 12 with a top flap 20B extending outwardly away therefrom and a bottom edge 14 with a bottom flap 23B extending outwardly away therefrom. Top and bottom edges 12, 14 are disposed along foldlines 3 and top and bottom flaps 20B, 23B are substantially coplanar with fourth panel 6b. Fourth panel 6b is separated from third panel 4b by a joint 17 that falls along another of vertical foldlines 5. A gap 29 is defined between each of top flaps 21A, 20B and bottom flaps 23A, 23B. Gaps 29 extend substantially from the foldline 3 to the respective outermost edge 2a, 2b of blank 2. Consequently, top flaps 21A, 20B are not connected to each other and bottom flaps 23A, 23B are not connected together.

As is apparent from a review of the present invention, hinges 24-27 may simply be manufactured of the same material and be integrally formed with blank 2. In this instance, hinges 24-27 are of the same thickness “T” as the rest of the material used in blank 2 and therefore may need to be cut with a knife or other implement in order to break the same. It will be understood that hinges 24-27 could, alternatively, be manufactured out of material with a reduced thickness relative to the rest of the blank, or could be made with a fracture line formed therein to make breaking the hinge easier. It will further be understood that hinges 24-27 may all be of different lengths. This is accomplished by increasing or decreasing the length of gaps 28.

Connector panel 7 has a top edge 11 and a bottom edge 13 that are disposed along the respective foldlines 3. A top connector flap 7A extends outwardly away from top edge 11 and a bottom connector flap 7B extends outwardly away from bottom edge 13. Top and bottom connector flaps 7A, 7B are substantially coplanar with connector panel 7. Connector panel 7 is separated from fourth panel 6b by a joint 18 that falls on another of foldlines 5. In accordance with a specific feature of the present invention, a portion of top flap 20B is separated from a portion of top connector flap 7A by a gap 28. A hinge 27 connects other portions of these flaps 20B, 7A together. Hinge 27 originates a distance outwardly from the associated foldline 3 and continues to the outermost edge 2a of blank 2. Similarly, a portion of bottom flap 22B is separated from a portion of bottom connector flap 7B by a gap 28. A hinge 25 connects other portions of flaps 22B, 7B together. Hinge 25 originates a distance outwardly from the associated foldline 3 and continues to outermost edge 2b of blank 2.

FIG. 1A shows that the blank 2 has a first height H1 as measured between the outermost edges 2a and 2b. The panels are all of a second height H2 as measured between top and bottom edges 8, 10 and 12, 14. The second height H2 is smaller than the first height H1. In a preferred embodiment of the present invention, a box that is suitably sized to be received within a standard size mailbag for a mail carrier has a first height H1 that is 44 cm and a second height H2 that is 28 cm.

FIG. 1C shows an alternative blank 2 that may be used to form box 1. The blank is substantially identical to the blank illustrated in FIGS. 1A and 1B except that the connector flap 7 does not have flaps 7A and 7B connected thereto. Instead, connector flap 7 has beveled edges 35, 37 and is of a height H2 as measured between edges 35, 37. Additionally, the fourth panel 6b is disposed adjacent the first panel 4a instead of being disposed between the third panel 4b and the connector panel 7 as was the case in the blank of FIG. 1A. In this version of the blank, the fourth panel 6b is separated from the first panel 4a by a joint 19. Furthermore, the flap 20B is connected to flap 21B by a hinge 33 and the flap 22b is connected to the flap 23B by a hinge 31. The box constructed from this blank is substantially identical in external appearance to the box constructed from the blank shown in FIGS. 1A and 1B. It will be understood that other modifications may be made to blank 2 without departing from the scope of the present invention.

In accordance with the present invention, a shipping address label 70 preferably is applied to exterior surface “E” of either version of blank 2 before construction of the box 1 begins. Label 70 preferably includes a plurality of spaced apart horizontal lines that a consumer may use to write a shipping address. Label 70 may be printed directly onto the exterior surface “E” of blank 2 or may be an adhesive type label that is applied onto exterior surface “E”.

In accordance with yet another specific feature of the present invention, a prepaid postage decal 72 is also applied to the exterior surface “E” of blank 2. The prepaid postage decal 72 represents a flat rate for mailing the erected and loaded box through the mail. This flat rate is a pre-negotiated rate with a postal service of any particular country or countries and is dependent upon the dimensions of the box once erected and upon the maximum permissible weight of the box once loaded. Preferably, the flat rate is not dependent upon the delivery address of the loaded box if delivered within a pre-negotiated region. For example, the flat rate may be a rate negotiated with either or both of the postal services of the United States and Canada for delivery of a box of particular dimensions and maximum weight anywhere within North America.

Decal 72 may be printed directly onto the exterior surface “E” or may be an adhesive label that is applied thereto. Both of the label 70 and decal 72 preferably are applied in regions of the blank 2 that are adjacent one of the top and bottom edges 8, 10, 12, 14 and which will be covered by one of the top and bottom flaps as will be hereinafter described when the blank 2 is folded.

When box 1 is erected, the panels and flaps are folded about these horizontal and vertical foldlines 3, 5 as will be hereinafter described. In the erected box panels 4a and 4b comprise a pair of opposed, substantially parallel and spaced apart sidewalls 4 and panels 6a and 6b comprise a pair of opposed, substantially parallel and spaced apart enwalls 6. The top flaps 21B, 20A, 21A, and 20B are folded inwardly toward each other to close off access to a top opening in the box. The bottom flaps 22B, 22A, 23A, and 23B are folded inwardly toward each other to close off access to a bottom opening in the box.

It will be understood that hinges 24, 25, 26 and 27 may be of any of a variety of lengths without departing from the spirit of the present invention, but are preferably between ½ and 2 inches in length. Furthermore, while hinges 24, 25, 26 and 27 are shown as being located proximate the outermost edges 2a, 2b, they may be spaced a distance inwardly away therefrom without departing from the spirit of the present invention.

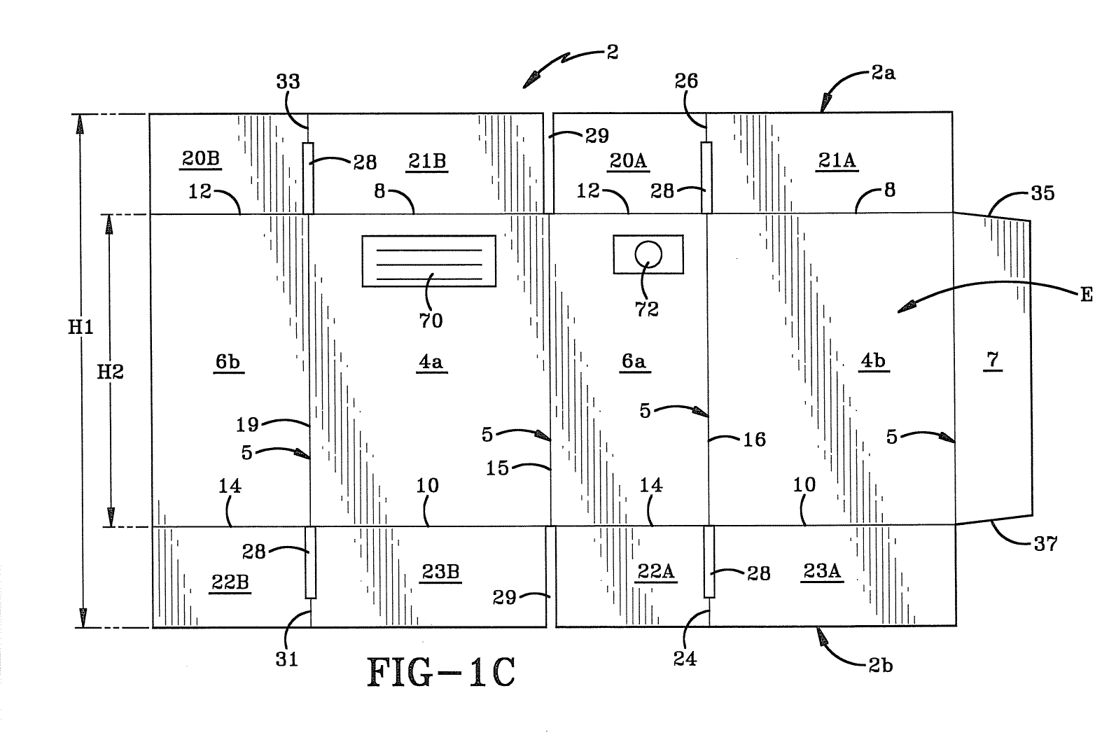

Blank 2 is erected into a box 1 in the following manner. The planar sheet of material that comprises blank 2 is folded about each of the foldlines 5. Blank 2 is folded along the foldline 5 between fourth panel 6b and connector panel 7 and the connector panel 7 is caused to overlap a portion of first panel 4a. This causes connector flap 7A to overlap a portion of top flap 21B and causes bottom connector flap 7B to overlap a portion of bottom flap 22B. An adhesive or other securing mechanism is applied between the overlapped areas to fixedly secure connector flap 7 to first panel 4a, top connector flap 7A to top flap 21B, and bottom connector flap 7B to bottom flap 22B. The blank 2 is then manipulated to fold along the appropriate foldlines 5 to form joints 15 and 17 (FIG. 2) and is oriented so that these joints 15, 17 constitute the outermost corners of the blank 2. In order to do this, box 1 is moved from the position shown in FIG. 1 to the position shown in FIG. 2 by rotating box 1 in the direction of Arrow A (FIG. 2) and by flexing joints 15 and 17 to have a 180° bend associated therewith. Joints 16 and 18 are moved to a substantially flat configuration. In this first folded position (FIG. 2), hinges 24, 25, 26, and 27 are disposed in the region of the box that is intermediate the outer corners formed by joints 15 and 17. It will be understood that gaps 29 are oriented along joints 15, 17 and are therefore disposed along the outer corners when box 1 is in this first folded position. It should also be noted that at this point FIG. 2 illustrates the exterior surfaces of the box 1, and most specifically the exterior surfaces of second panel 6a, third panel 4b together with their top flaps 20A/21A and bottom flaps 22A/23A. If the box 1 were flipped over, then the exterior surfaces of the fourth panel 6b and the first panel 4a and their associated flaps 21B/22B and 20B/23B would be seen.

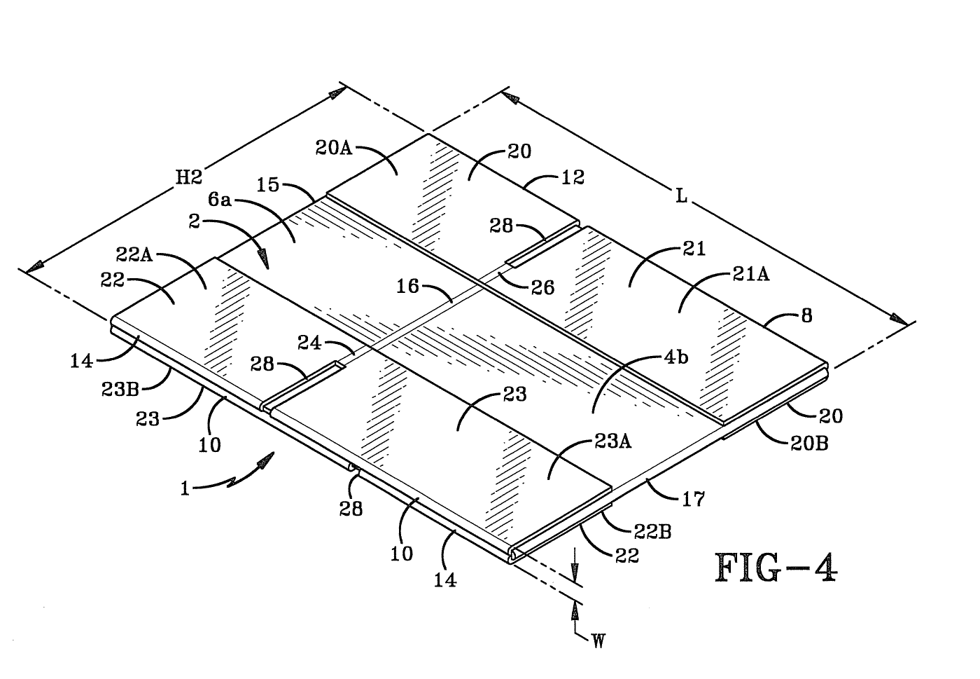

Once the box 1 is in the position shown in FIG. 2, then the top flaps 20A/21A, which are joined together by hinge 26, and the top flaps 20B/21B, which are joined together by hinge 27, are rotated along Arrows B and C, respectively, until they are in the position shown in FIG. 3. Similarly, bottom flaps 22A/23A, which are joined together by hinge 24, and bottom flaps 23B/22B, which are joined together by hinge 25, are rotated in the direction of Arrows D and E, respectively, until they are moved into the position shown in FIG. 3. As these joined flaps 20A/21A; 20B/21B and 22A/23A; 23B/22B continue to be rotated, they will ultimately move to the position shown in FIG. 4. In this position, the exterior surfaces of each of the joined top flaps 20A/21A and 20B/21B abut the exterior surface of the associated first, second, third and fourth panels. Consequently, when box 1 is in the position shown in FIG. 4, the interior surfaces of the flaps 20A/21A; 22A, 23A are visible. Similarly, if the box 1 were flipped over, the interior surfaces of flaps 20B/21B and 23B/22B would be visible.

Referring particularly to FIG. 4, box 1 is shown in a first collapsed position with first hinge 24 and second hinge 26 aligned along joint 16 and where the joint is substantially flattened so that the second panel 6a is substantially coplanar with the third panel 4b. It will be understood that, similarly, third hinge 26 and fourth hinge 27 are aligned along joint 18 which is also substantially flattened with the fourth panel 6b and first panel 4a being substantially coplanar with each other. As mentioned previously, in this first collapsed position, joints 15 and 17 include a 180° bend and constitute the outer corners of the collapsed box.

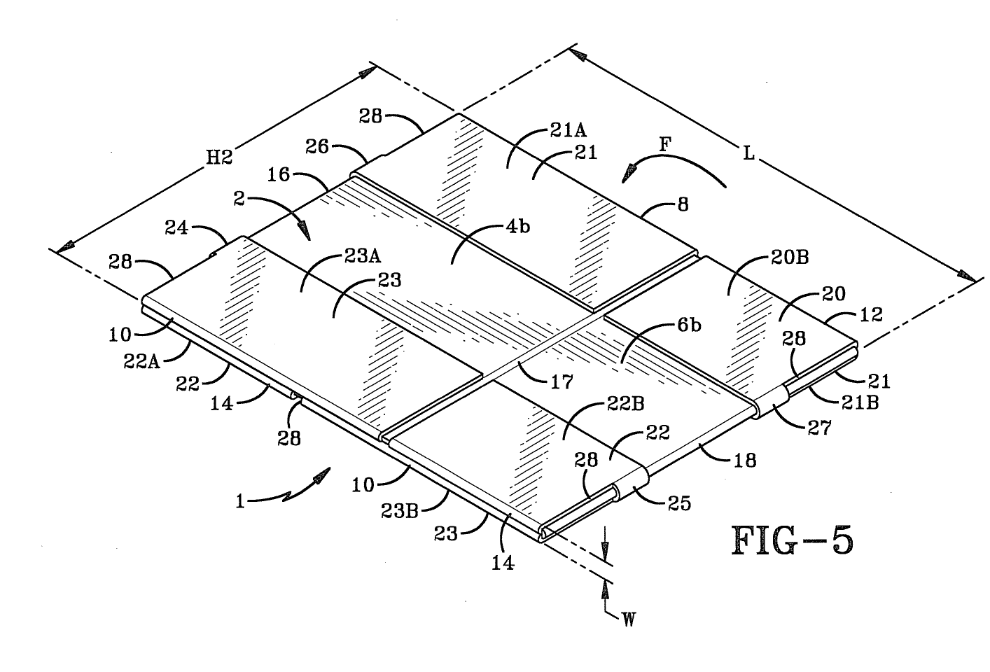

Box 1 is then moved from the first collapsed position (FIG. 4) into a second collapsed position (FIG. 5) by rotating box 1 in the direction of Arrow F. This causes the panels to move so that joints 16 and 18 are positioned at the outermost corners of box 1. Each joint 16, 18 has a 180° bend therein and each joint 15 and 17 is substantially flattened. By rotating the box along the direction of Arrow F, it can be seen that first hinge 24 and third hinge 26 are moved into a position where they have a 180° bend in them as they wrap around joint 16. Second hinge 25 and fourth hinge 27 also are caused to have a 180° bend as they wrap around joint 18. The forces supplied by hinges 24-27 assure that the top flaps 20A/21A and 20B/21B and the bottom flaps 22A/23A and 23B/22b are all held in abutting contact with the exterior surface of the associated panels 4a-6b. Hinges 24-27 provide sufficient force to assure that the free ends of each of the top and bottom flaps adjacent gaps 29 are also held in abutting contact with the exterior surface of the associated panels 4a-6b.

When box 1 is in this second collapsed position it is in a configuration that is suitable for shipping. Box 1 in this second collapsed position is of a reduced height relative to the original blank 2. The overall height of box 1 when it is in each of the first and second collapsed positions is H2. In other words, the height of box 1 is substantially equal to the height H2 of the panels 4a-6b alone. This is due to the fact that the top and bottom flaps have been folded into abutting contact with the exterior surface of the panels 4a-6b. This arrangement allows the user to more easily ship the box 1 as it is of a diminished size relative to the original blank 2. The overall thickness W of box 1 in the second collapsed condition is equal to the combined thickness of two abutting panels, such as 4b and 6b and two flaps, such as 21A and 20B. The diminished dimensions of box 1 in the second collapsed condition preferably is one that is suitable for easy insertion of the box into a standard size mailbag for a mail carrier. Additionally, the positioning of hinges 24-27 on the outermost corners presents a box configuration that does not have free edges that can snag or catch on other objects being shipped, mailed or carried in a mailman's bag. Additionally, the diminished dimensions of box 1 when in the first or second collapsed condition also makes it possible to store or display box 1 in a smaller space compared to previously known boxes in which the top and bottom flaps extend outwardly away from and coplanar with the panels that form the sidewalls and enwalls thereof.

It is often appropriate to provide information such as assembly instructions or the like on a piece of packaging. In accordance with a specific feature of the present invention and referring to FIG. 6, it can be seen that a printer 30 may be utilized to print indicia 32 onto the interior surface “I” of at least one of the top and bottom flaps, such as top flap 21A. Inasmuch as this printed indicia 32 is on the interior surface of top flap 21A, when box 1 is fully erected and moved to the closed position as will be discussed hereinafter, the indicia will be moved to a position disposed in the interior of the box and will not detract from the appearance of the box exterior. It will be understood that instead of printing directly onto the folded blank 2, an adhesive label containing the printed indicia 32 may be applied to the interior surface “I” of one of the top and bottom flaps. It will be understood that if the printed indicia 32 is a shipping address then that address may be one that is selected from a computerized database of addresses of consumers to whom the folded blanks 2 are to be mailed.

In accordance with a specific feature of the present invention, the printed indicia 32 preferably, but not exclusively, includes a shipping address for a consumer. This shipping address enables the post office or a shipping company to ship the box when in a second collapsed condition (FIG. 6) to a remote consumer.

In accordance with another specific feature of the present invention, it is possible to ship a number of boxes together when in the second collapsed position. This is illustrated in FIG. 6A where three folded blanks 2 are shown in the second collapsed position. The folded blanks are stacked one on top of the other and are banded together by restraining straps 80. A single shipping label, in the form of indicia 32, is applied to one of the flaps on an outermost blank 2. Although not illustrated herein, it will be understood that one or more restraining straps 80 may also be applied around a single folded blank 2 in a position that will ensure the top and bottom flaps do not separate from the exterior surface “E” of panels 4a-6b. This strap 80 will ensure that no loose corners of the top and bottom flaps become damaged as the folded blank is shipped.

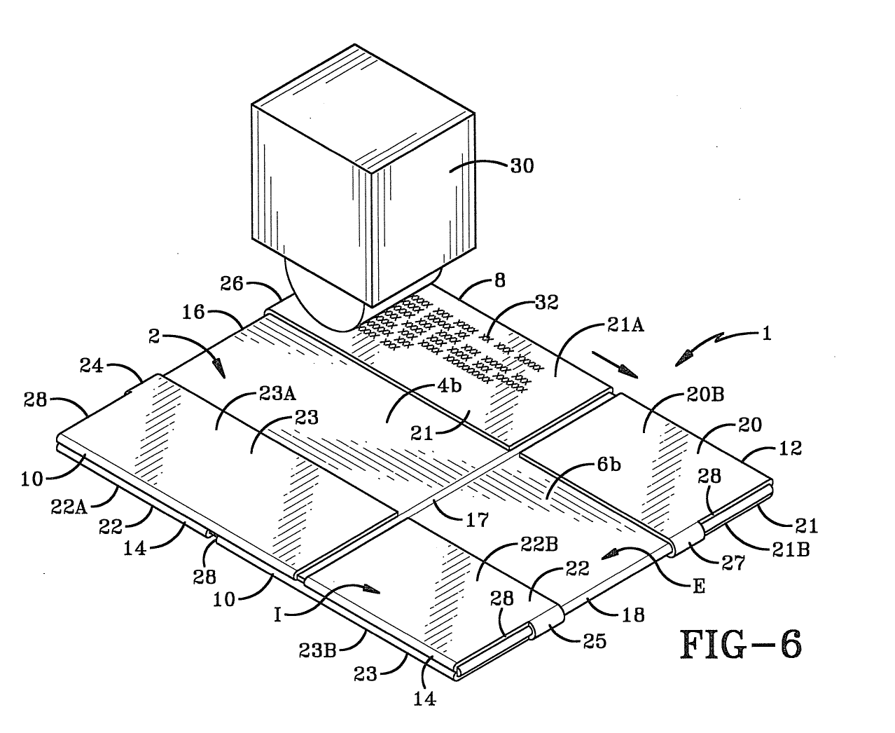

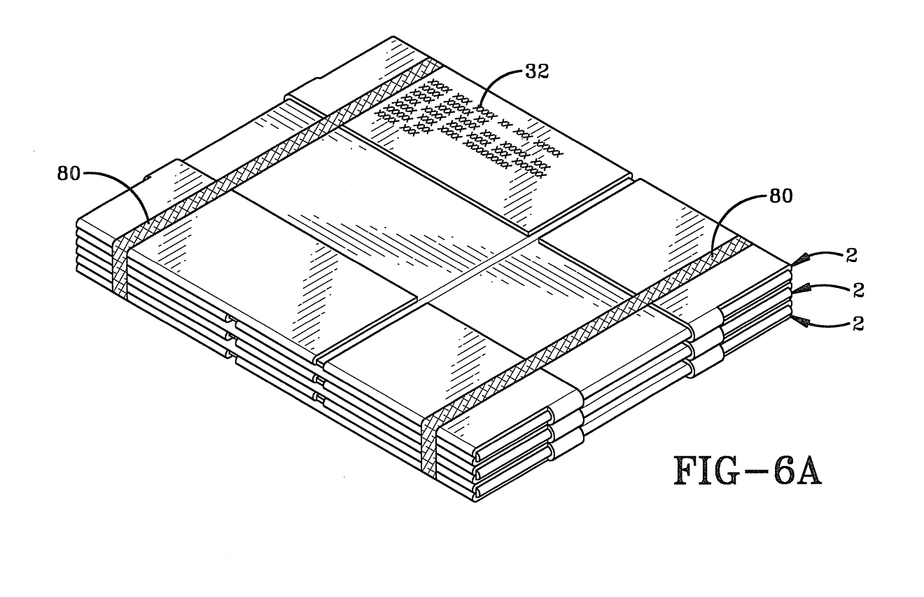

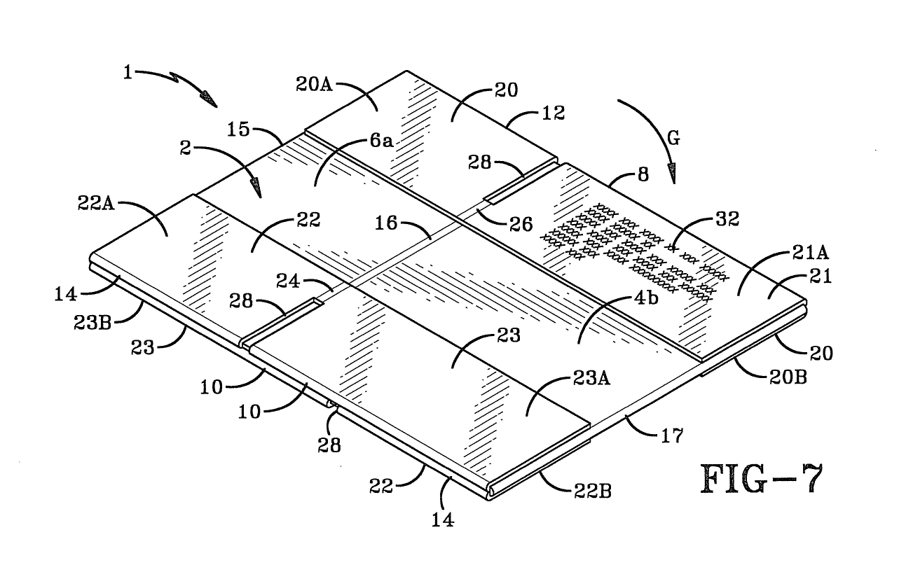

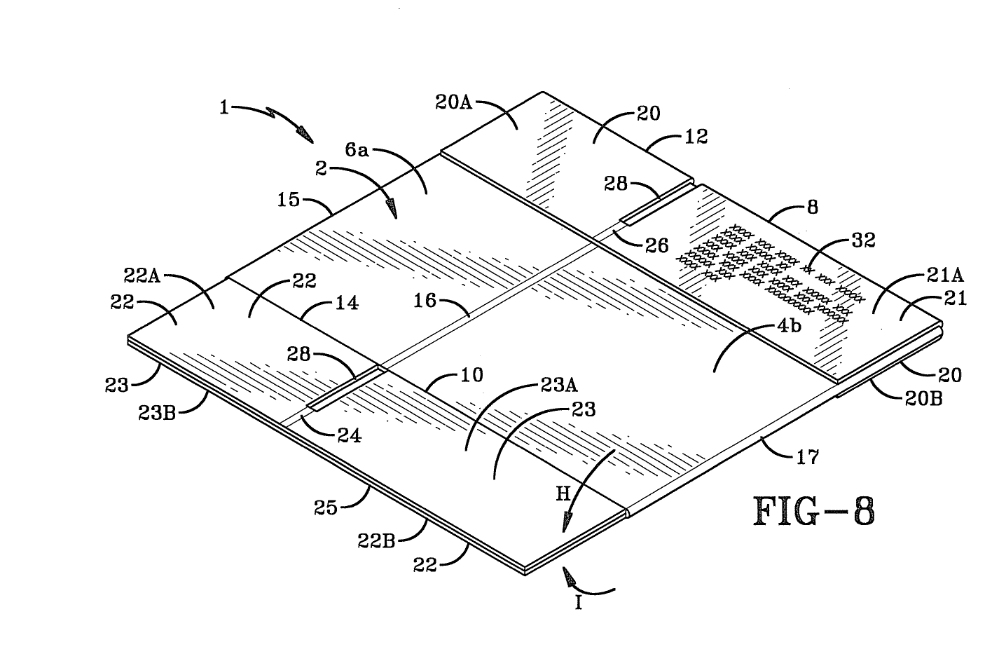

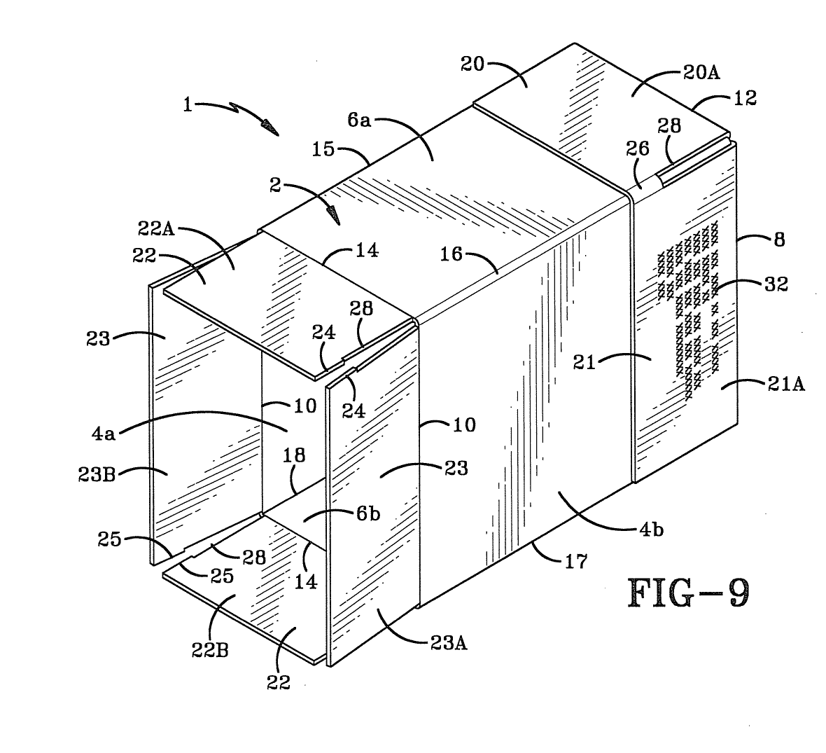

Referring to FIG. 7, the folded blank 2, having been received or purchased by the consumer in the second collapsed position, may now be erected into a position where it is ready for use. The erection of box 1 is accomplished as follows. Firstly, the folded blank 2 is moved from the second collapsed position back to the first collapsed position, i.e., blank 2 is rotated from the position shown in FIG. 7 along the direction indicated by Arrow G to the position shown in FIG. 8. This causes hinges 24-27, which were disposed at the outer corners of the blank in FIG. 7 to be moved away from the outer corners and to a position where they are disposed intermediate the outer corners. In this first collapsed position, flaps 20A and 21A remain in abutting contact with the exterior surface “E” of the associated panels 4a-6b. Bottom flaps 22B, 22A, 23A, 23B are then rotated downwardly in the direction of Arrows H and I as shown in FIG. 8 to where they once again extend coplanar with and outwardly away from panels 4a-6b. Box 1 is then moved to a partially erected state (FIG. 9) with top flaps 21B, 20A, 21A, 20B remaining in abutting contact with the exterior surface “E” of the panels 4a-6b and with the hinges 26 and 27 intact. Hinges 24 and 25 on bottom flaps 22B, 22A, 23A, 23B are broken apart (FIG. 9). This permits the bottom flaps 22B, 22A, 23A, 23B to be rotated in the direction of Arrows J inwardly toward each other and so as to close off the bottom opening of box 1 (FIG. 10). A suitable sealing mechanism, such as an adhesive or staples is then applied to bottom flaps 22B, 22A, 23A, 23B to fix them in place relative to each other. Box 1 is now in a loadable condition where any desired articles 34 may be introduced into the cavity defined by panels 4a-6b and bottom flaps 22B, 22A, 23A and 23B. Box 1 may be loaded with articles goods 34 while top flaps 21B, 20A, 21A, 20B remain positioned in abutting contact with the exterior surface “E” of panels 4a-6b. Top flaps 21B, 20A, 21A and 20B remain in this position as they are held there by hinges 26 and 27.

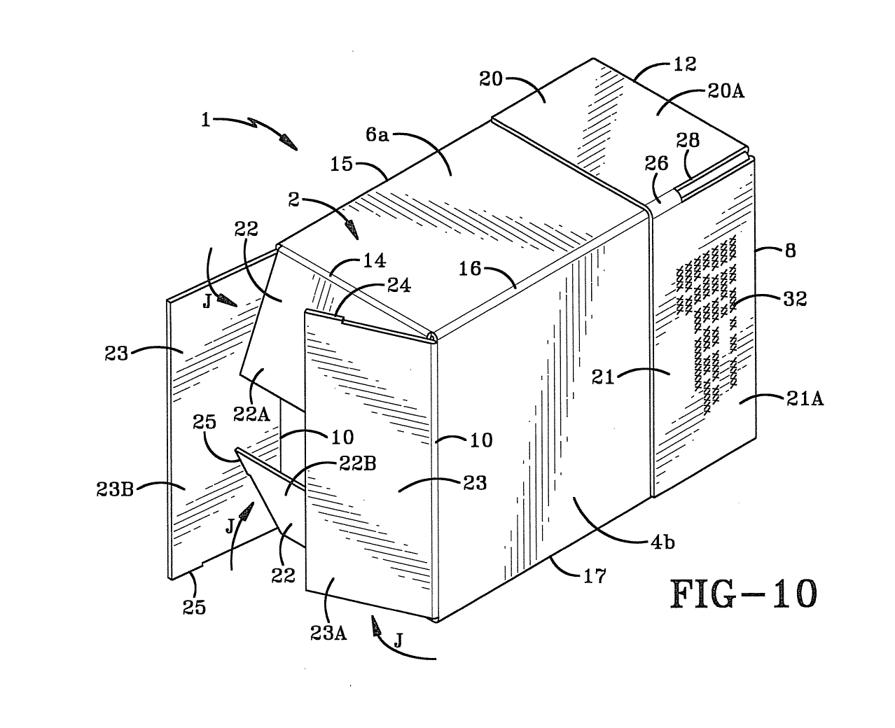

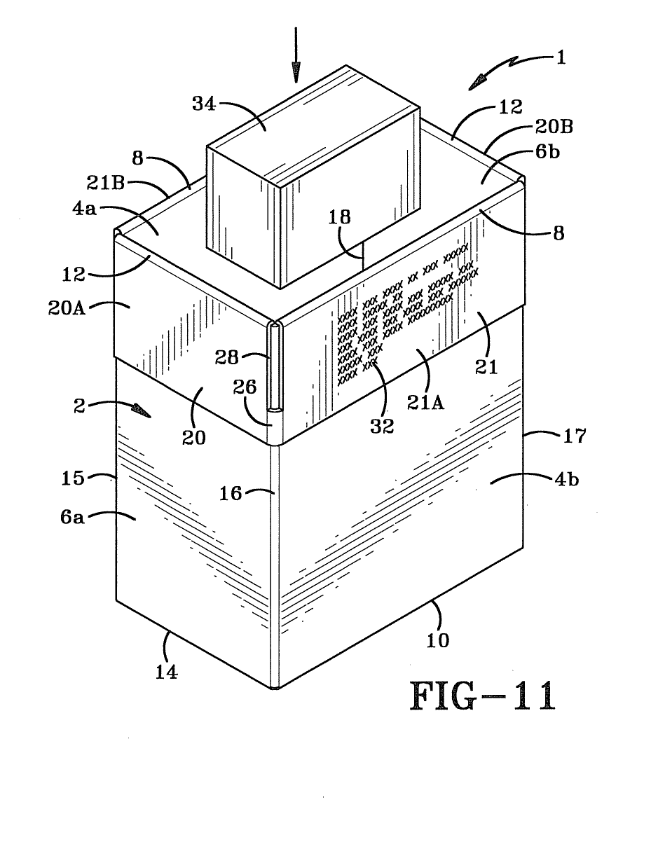

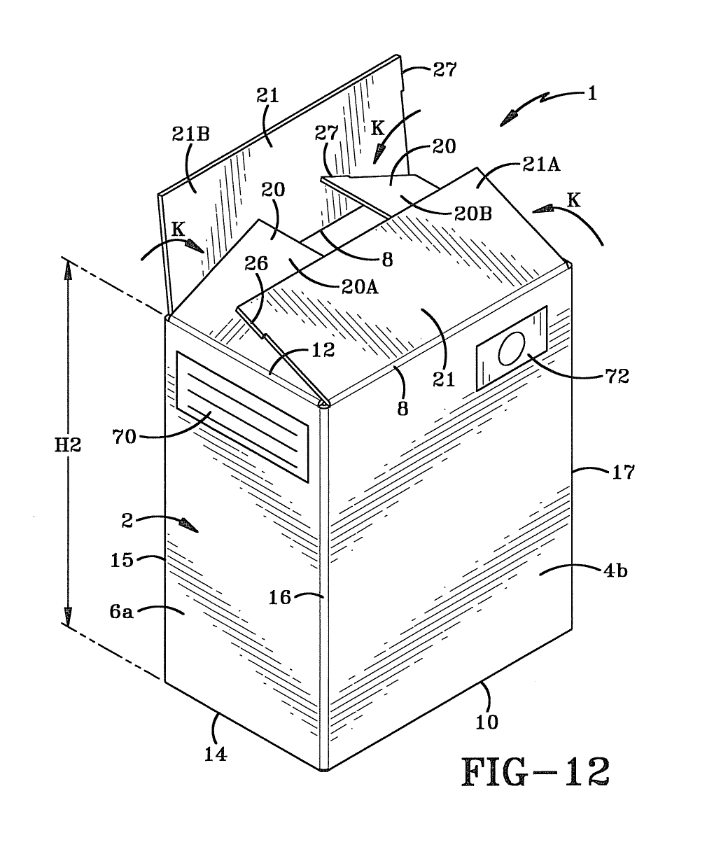

FIG. 11 shows that at this stage, indicia 32 are still visible as the interior surface “I” of top flap 21A upon which the indicia are printed still faces outwardly. Once box 1 is fully loaded, hinge 26 and hinge 27 are broken and top flaps 21B, 20A, 21A, 20B are rotated inwardly toward each other in the directions of Arrows K and into the closed position as shown in FIG. 12. When this occurs, the interior surface “I” of top flaps 21B, 20A, 21A, 20B is disposed within the interior of box 1 and indicia 32 are no longer visible. Thus, the exterior appearance of box is not marred by the indicia 32 once box 1 is closed.

As is evident from the above description and method of operation, box 1 may be shipped and stored in a relatively small space limited to only to the height H2 of panels 4a-6b and to the thickness “W” (FIG. 5) and length “L” of body 2 when in the second collapsed position (FIG. 5 or 6). In the preferred size of box that is suitable for carrying in a standard size mailbag for a mail carrier, the second height H2 is 28 cm, the thickness “W” is around 1 cm and the length “L” is around 35 cm.

As is also apparent and in accordance with one of the primary features of the invention, a portion of the interior surface of box 1 may be easily printed with directions or information assuring that when the box is in the closed position, there is no information on the exterior of the box to get in the way of further shipping or packaging. Thus, the folded box 1 shown in FIG. 6 can be shipped to a consumer with the shipping address printed as indicia 32 on the interior surface “I” of one of the flaps. But, once the box 1 is fully erected, loaded and closed, it may be shipped to a second consumer at a remote location without indicia 32 being visible. The shipping address that constituted indicia 32 is no longer visible since the flap containing said indicia has been folded so that the exterior surface of that flap is now visible instead of the interior surface thereof. This removes the likelihood of any confusion as to which is the correct address for delivery of the loaded box. Once the box 1 is fully loaded with articles, the first consumer may write the mailing address of the second consumer onto the mailing label 70 applied to the exterior surface “E” of one of the panels.

While it has been illustrated herein that the blanks 2 are printed with the indicia 32 when in the second folded position, it should be understood that such indicia 32 may be printed on the blank 2 prior to it be folded (i.e. when it is in the position shown in FIG. 1B) or when the blank 2 is in the first folded position (FIG. 4). Preferably, shipping label 70 and decal 72 are applied to blank 2 when it is still a planar sheet (FIG. 1A).

FIG. 1A shows that the distance between the outermost edges 2a, 2b of blank is the first height identified as H1 and the distance between the two horizontal fold lines 3 is identified as the height H2, with H2 being smaller than H1. As seen from FIGS. 5 and 12, the height of both the shipped box (FIG. 5) and the erected box (FIG. 12) is H2, i.e., the height of the panels 4a-6b. This is in contrast to previously known erectable boxes where the height of the shipped box would be the equivalent of the height H1 and the height of the previously known erected box would be the equivalent of the height H2. The present inventor has therefore found a way to reduce the overall size of a shipping box to substantially the same height as the erected box and not substantially the height of the blank as was previously the case. This arrangement reduces the mailing cost for collapsed boxes sent through the regular mail as the postage rates are at least partially determined by the overall dimensions of the article shipped.

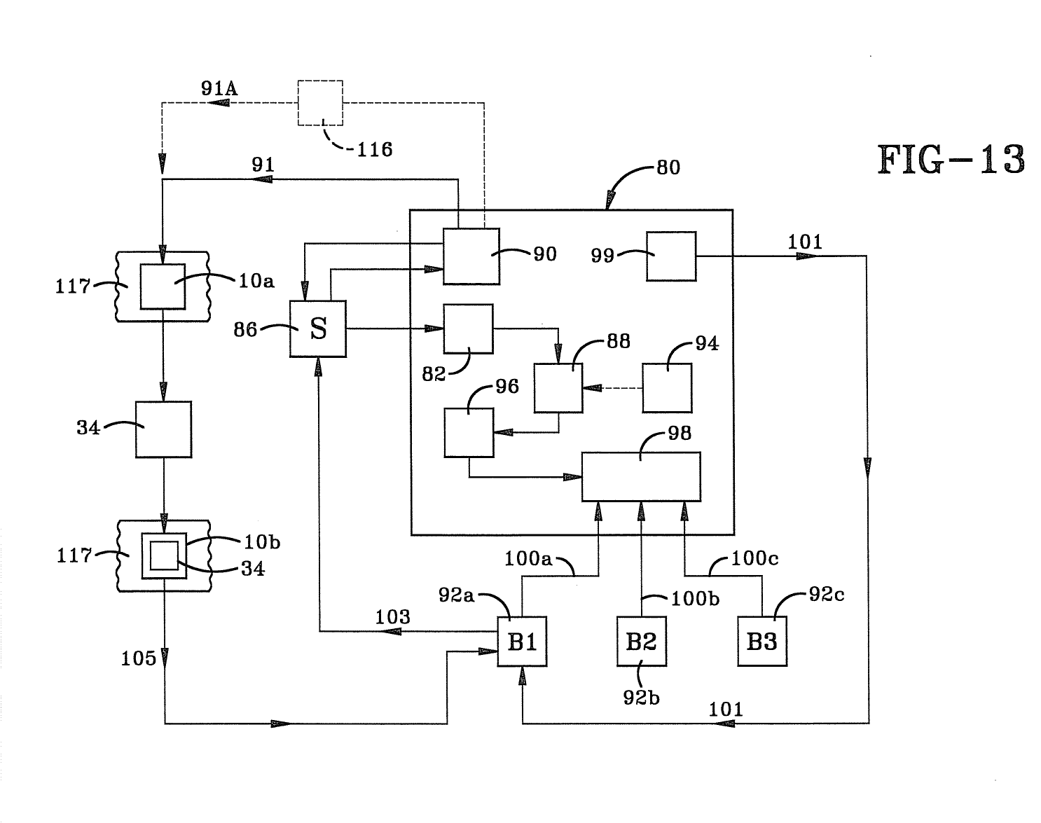

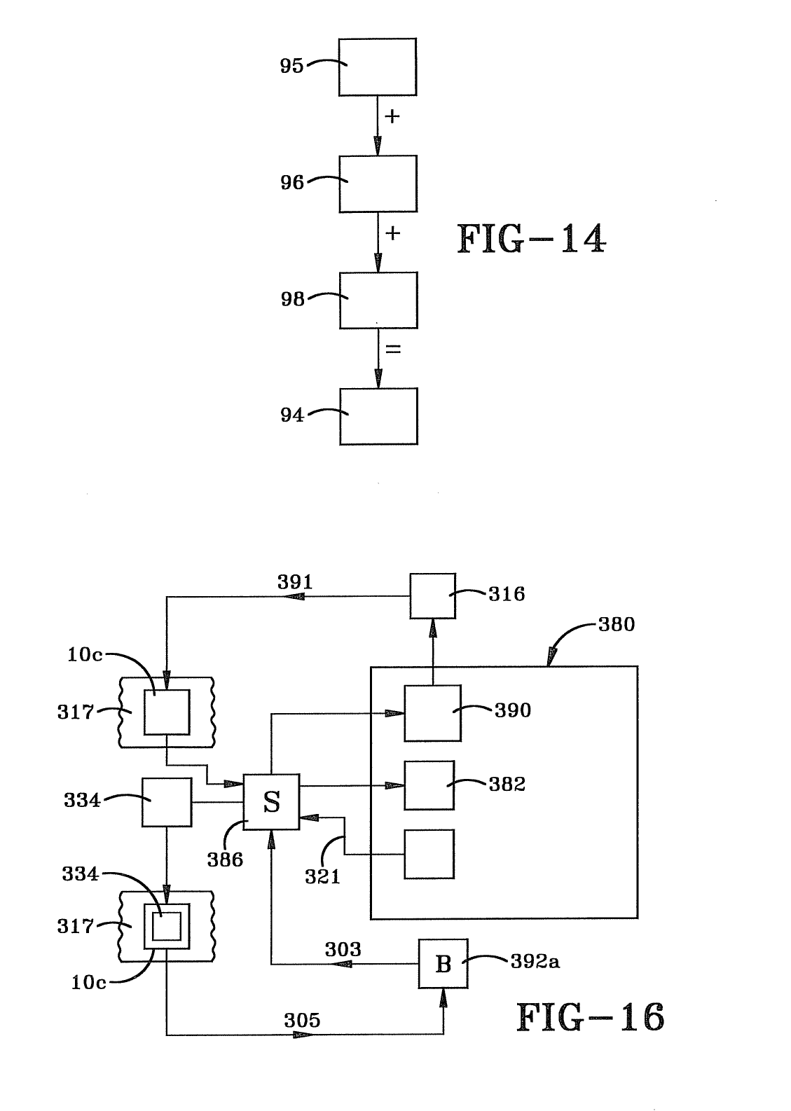

Referring to FIGS. 13-14 and in accordance with the present invention there is disclosed a first method of selling and shipping a product 34 utilizing the internet and using the packaging box 10 described hereinbefore. The method comprises the steps of:

a) providing an online auction site 80 on the internet;

b) receiving an online listing 82 for a product 34 from a seller 86,

c) offering seller 86 an opportunity to purchase 90 a box 10 for subsequent shipping of product 34;

d) determining the starting bid 96 for product 34;

e) posting an auction listing 98 for product 34 on auction site 80 which incorporates the starting bid 96;

f) receiving a plurality of bids 100a, 100b, 100c for product 34 from a plurality of potential buyers 92a, 92b, 92c over a predetermined period of time;

g) determining the highest bid, 100a for example, from the plurality of bids 100a-100c when the period of time has elapsed;

h) determining a shipping cost 94 for shipping product 34;

i) determining the amount of money 99 to be paid to the seller;

j) contacting 101 buyer 92a with the highest bid 100a to advise them that they have won the auction for product 34; and

k) advising buyer 92a with the highest bid 100a of the amount of money 99 to be paid directly to seller 86.

The process further includes the buyer 92a paying 103 seller 86 directly and then the seller 86 loading product 34 into appropriate packaging and shipping 105 product 34 to buyer 92a.

As part of the above process, the shipping costs 94 must be readily available for potential buyers 92a-92c to view on online auction site 80. If seller 86 was to utilize packaging they already have on hand to ship, then determining the shipping cost 94 in a country such as the United States would pose little problem as that may be determined from information provided on the US Postal Service's website, www.usps.com, Typically, a link to this website would be provided on the online auction site 80. However, in countries such as Canada, shipping costs could not be previously determined unless the addresses of both the seller 86 and the winning buyer 92a-92c were known. This proved to be problematic as the seller 86 would not wish to post their home address on the website 80 and the potential buyer making the bid would therefore be unable to determine postal rates for shipping the packaging through the mail. Consequently, it was previously impossible for potential buyers 92a-92c to determine shipping costs before they submitted their bids.

However, in accordance with the present invention, the Applicant has negotiated, with various postal services including the Canadian Postal Service, a flat-rate for shipping box 10, fully erected and loaded with a product such as product 34. The actual flat rate cost varies in accordance with whether the box is to be shipped regionally or nationally within Canada, or is to be shipped to the United States. This flat rate box therefore enables seller 86 to mail product 34 to any location within Canada or the United States for a set rate. An example of a box suitable for these flat rates is one that has a second height H2 that is around 28 cm.×21.5 cm×14 cm and carries no weight greater than 5 kg. Thus, it is possible for potential buyers 92a-92c to determine shipping costs 94 via a link on online auction site 80 prior to submitting a bid 100a-100c.

Starting bid 96 may comprise only a starting price 88 provided by seller 86. Alternatively, seller 86 may decide to include some or all of the shipping costs 94 as part of starting bid 96. In this second instance, seller 86 will add their starting price 88 to shipping cost 94 and post that total amount as starting bid 96. This second option is indicated by the dashed line between shipping costs 94 and starting price 88 in FIG. 13.

In accordance with the present invention, and as illustrated in FIG. 14, determining the shipping cost 94 requires a plurality of steps. Firstly, the seller must determine a first amount of money 95 that is reflective of the cost for purchasing a selected size of box 10. To this first amount of money 95, seller 86 must add a second amount of money 96 reflective of the cost for shipping 91 the box 10 to seller 86 in a collapsed condition. The collapsed box is identified in FIG. 13 by the number 10a. The second amount of money 96 is determined by the seller selecting a non-flat rate amount of money from a list provided by the postal service and based on the dimensions of the collapsed box 10 they intend to order. A third amount of money 98 must then be added to the first and second amounts 95, 96 to arrive at the shipping cost 94. This third amount of money 98 is reflective of the cost for mailing 105 the erected and loaded box, identified by the number 10b in FIG. 13, through the mail to one of the potential buyer 92a-92c. In accordance with one of the specific features of the present invention, this third amount of money 98 is the negotiated flat rate of postage previously discussed.

It will be understood that the box 10 may, alternatively, be offered for purchase 90 to seller 86 at no cost, i.e. the first amount of money 95 and second amount of money 96 will both be equal to $0, i.e., box 10 will be mailed to the seller free of charge. In this instance, the first and second amounts of money 95, 96 could be incorporated into the third flat rate amount of money 98 the seller 86 will pay for mailing 105 the loaded box to the buyer. It will further be understood that since the dimensions of the collapsed box 10 are known, the second amount of money 96 for shipping 91 the collapsed box 10a to the seller may also be a flat rate charge instead of a non-flat rate charge.

If, seller 86 decides to purchase a box 10 upon viewing the offer to purchase 90, then box 10 may be shipped 91 directly to seller 86 from the company hosting the online auction site 80. Alternatively, the site 80 may include a link to redirect seller 86 to a remote packaging supplier 116 so that they may place an order for collapsed box 10. In this instance, box 10 will be shipped from the packaging supplier 116 to seller 86. This alternative pathway is illustrated as 91A in dashed lines on FIG. 13. Obviously, it will be understood that a courier type service may be utilized to ship the collapsed box 10a to seller 86 instead of the box being delivered through the mail.

It will further be understood that the box 10a is of the type described herein and illustrated in the attached FIGS. 1-12. Consequently, the step of shipping 91 the collapsed box 10a comprises the steps of: providing a box 10 (FIGS. 1a & 5) that has four side panels 4, 6, each panel having a top edge 8, 12 and a bottom edge 10, 14 with a top flap 20, 21 extending outwardly from the top edge and a bottom flap 22, 23 extending outwardly from the bottom edge; and wherein each panel 4, 6 is of a second height H2 as measured between the top and bottom edges 8, 12 and 10, 14 thereof; and collapsing the box for shipping in such a manner that the collapsed box has a height that is equal to the second height H2.

Additionally, since box 10a has a first hinge 26, 27 that connects two of the top flaps together and has a second hinge 24, 25 that connects two of the bottom flaps together; the step of providing the box further includes moving the box into a first position (FIG. 2) where neither of the first and second hinges 26, 27, 24, 25 falls on an outermost corner of the box; folding all of the top and bottom flaps 20, 21, 22, 23 into abutting contact with an exterior surface of the side panels 4, 6; moving the box from the first position (FIG. 2) to a first collapsed condition (FIG. 4) and then into a second collapsed condition (FIG. 5) where at least one of the first and second hinges 26, 27, 24, 25 falls on an outermost corner of the box; whereby the box 10 is ready for shipment.

As previously discussed herein, one of the issues facing mail delivery of previously known boxes is that the top and bottom flaps extend outwardly away from the panels when the box is in a collapsed state. This effectively prohibited a variety of different size boxes from being deliverable by mail in regions such as Canada, the United Kingdom and Australia as the boxes were too large to be carried within a standard size mail carrier's mailbag. In accordance with a specific feature of the present invention, box 10a when collapsed (FIG. 5) is of the same overall height as when fully erected and sealed (FIG. 12). The height of both the collapsed box 10a and the erected and sealed box is the same height H2 i.e., it is the same height as the box panels 4,6 as measured between the top and bottom edges 8,12 and 10,14 thereof. Height H2 is of such a size when collapsed and erected that the box 10a, 10b is able to be inserted into the interior of a standard size bag 117 (FIG. 13) of a mail carrier.

The method of shipping further includes applying a shipping label 32 to the box 10 when in either one of the first and second collapsed conditions (FIG. 6). This is accomplished by selecting a printing location on the box 10 such that the shipping label 32 will not be visible when the box 10 is loaded with product 34 and is ready to be shipped to buyer 92a. Preferably, the step of applying the shipping label includes printing a mailing address for seller 86 on one of the top and bottom flaps 20, 21, 22, 23 of the collapsed box 10a. The mailing address is selected from a database of sellers (not shown) maintained by the company hosting the online auction site 80. Box 10, in either of the first and second collapsed conditions (FIGS. 4&5), is passed beneath a print head 30 (FIG. 6); and the mailing address 32 is printed onto an outwardly facing interior surface “I” of the one of the top and bottom flaps.

The method further includes the applying a pre-paid postal decal 72 onto one of the side panels 4, 6 of the box 10 prior to it being collapsed. This step is accomplished by printing decal 72 on one of side panels 4, 6 in an area to be covered by one of top and bottom flaps 20, 21, 22, 23 when box 10 is in either of the first and second collapsed conditions. The method further includes the step of applying a second mailing label 70 to one of side panels 4, 6 of box 10. This may include printing a plurality of horizontal lines onto the side panels, wherein the lines are configured so as to permit seller 86 to write in a mailing address for the winning buyer 92a. The method further comprises the step of shipping 91 the collapsed box 10a to the seller at one of a non-flat rate and flat-rate postage.

The seller may decide to order more than one box when they view the offer to purchase 90 on site 80. In this instance, the method further includes the steps of stacking at least one additional collapsed box 10 one of on top or beneath the collapsed box (FIG. 6A); and binding the two stacked boxes together. The step of binding boxes 10 together may further include wrapping a length of retaining tape 80 around the stacked boxes 10; and securing retaining tape 80 in place so boxes 10 do not become disengaged from each other. The step of shipping 91 the stack of boxes 10 to seller 86 preferably also includes applying the shipping address 32 of seller 86 onto one of a top and a bottom flap of the outermost one of the stacked collapsed boxes.

When seller 86 receives box 10a, they move it from the second collapsed condition (FIG. 8) to an erected condition (FIG. 9); seal the bottom flaps of the box together (FIG. 10); load product 34 into erected box 10 (FIG. 11); and seal the top flaps of the box together (FIG. 12). Seller 86 then inserts the address of the buyer 92a on second mailing label 70. This may be done by physically writing the address onto the horizontal lines provided on label 70. Alternatively, online auction site 80 may provide a link to print said address onto a label that may then be applied in the region of the box indicated by second mailing label 70.

The erected and loaded box 10b is then mailed 105 to buyer 92a. Seller 86 may take loaded box 10b to the post office for mailing of the same or may use a link (not shown) on online auction site 80 or may go directly to the appropriate postal service website to pay the flat rate postage for mailing the box. Once the postage is paid, a paid postage label may be printed and then applied over the decal 72 on one of the side panels 4, 6 of box 10.

It will be understood that the erected box 10b is also of a size suitable for being received within a standard size mailbag 117 of a mail carrier. In the preferred embodiment of the invention, the erected box 10b has a height of 28 cm (which is the height H2 of the panels 4, 6), a length of 21.5 cm and a width of 14 cm and is designed to weigh no more than 5 kg. (These dimensions are the equivalent of 11 inches×8.5 inches×5.5 inches and a weight of around 11.02 lbs.) It will be understood that other size and weight boxes may also be used in the practice of this method.

Referring to FIG. 15 there is shown a second method of selling and shipping a product utilizing the internet. The method includes the steps of:

providing an online auction site 180 on the internet;

offering 190 a plurality of different size boxes 10c, 10d, 10e for a potential seller to purchase;

receiving an online listing 182 for a product 134 from a seller 186;

receiving an order 190a for a particular size box 10c from the seller 186;

determining a starting bid 196 for the product by adding a price for purchasing 195 and shipping 194 the particular size box to a starting price 88 selected by the seller 186;

posting an auction listing 198 for product 134 on the auction site 180 including the starting bid 196;

receiving a plurality of bids 200a, 200b, 200c from potential buyers 192a, 192b, 192c over a predetermined period of time;

determining the highest bid 200a, for example, from the plurality of bids 200a-200c after the period of time has elapsed;

contacting the potential buyer 192a with the highest bid 200a to advise them that they have won the auction for product 134;

advising the buyer 192a with the highest bid 200a how to pay the seller 186 directly; and

shipping 191 the particular size box 10 to the seller collapsed to a size suitable to be carried within a standard size mailbag 217 of a mail carrier; and

receiving payment 204 from the seller, wherein payment includes a commission and the price for purchasing 195 and shipping 194 the box to the seller 186.

Once the auction is closed and the seller has been notified of a winning bid and has been paid 203 by buyer 192a, the seller erects the collapsed box 10c, loads product 134 to be shipped into the erected box; and mails 205 the loaded box to buyer 192a at the flat postage rate associated with box 10c. The fully erected and loaded box is also of a size suitable for insertion into a standard size bag 217 for a mail carrier.

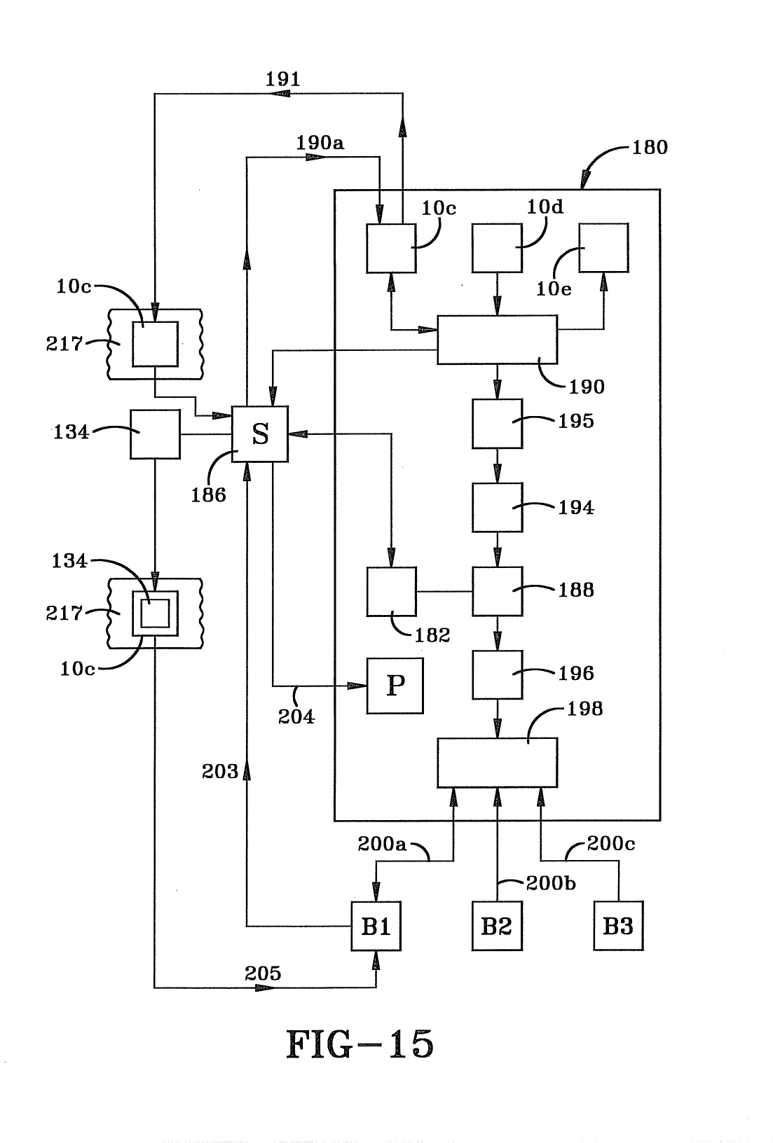

Referring to FIG. 16, there is shown a third method of selling and shipping a product utilizing the internet that includes the steps of:

creating an online listing 382 for a product 334 on an online auction site 380;

ordering a collapsed flat-rate box 10c from a packaging supplier 316 via an online link 390 on the online auction site 380;

receiving 391 the collapsed flat-rate box 10c from the packaging supplier 316, with that box 10c being delivered in a standard size mailbag 317;

receiving notification 321 of a winning bid from the online auction site 380;

receiving payment 303 for the product 334 from a buyer 392a;

erecting the collapsed box 10c;

loading the product 334 into the erected box 10c;

sealing the loaded box;

placing a mailing address for the buyer 392a on the box 10c; and

sending 305 the loaded flat-rate box 10c to the buyer 392a through the mail for a flat-rate fee.

Although not illustrated in FIG. 16, this third method of selling and shipping a product may also include paying a commission to the company hosting the online auction site, printing mailing address labels from a link on the online auction site and paying postage for mailing the loaded box via a link on the online auction site.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method of selling and shipping products utilizing the internet comprising the steps of:
a) providing an online auction site on the internet;
b) receiving an online listing for a product from a seller;
c) offering the seller an opportunity to purchase a flat-rate box for subsequent shipping of the product;
d) determining the starting bid for the product;
e) posting an auction listing for the product on the auction site, which listing incorporates the starting bid;
f) receiving a plurality of bids for the product from a plurality of potential buyers over a predetermined period of time;
g) determining the highest bid from the plurality of bids when the period of time has elapsed;
h) determining the amount of money to be paid to the seller by the buyer who made the highest bid; and
i) contacting the buyer with the highest bid to advise them that they have won the auction for the product.

2. The method as defined in claim 1, further comprising the step of:
shipping a collapsed box to the seller in the mail.

3. The method as define in claim 2, wherein the step of shipping the collapsed box includes shipping a box that is of a maximum height that is the same when the box is in a collapsed shipping condition and an erected and sealed condition.

4. The method as defined in claim 2, wherein the step of shipping the collapsed box includes collapsing the box for shipping such that the maximum height is substantially equal to a height of one of a plurality of side panels on the box.

5. The method as defined in claim 4, wherein the step of shipping the collapsed box comprises the steps of:
providing a box that has four side panels, each panel having a top edge and a bottom edge with a top flap extending outwardly from the top edge and a bottom flap extending outwardly from the bottom edge, and each of said top and bottom flaps having outermost edges spaced outwardly from the respective top and bottom edges of the panels; and wherein the height of one of the panels is measured between the top and bottom edges thereof.

6. The method as defined in claim 5, wherein the box has a first hinge that connects two of the top flaps together and has a second hinge that connects two of the bottom flaps together; and the step of providing the box further includes
moving the box into a first collapsed condition where neither of the first and second hinges falls on an outermost corner of the box;
folding all of the top and bottom flaps into abutting contact with an exterior surface of the side panels; and
moving the box from the first collapsed condition into a second collapsed condition where at least one of the first and second hinges falls on an outermost corner of the box;
whereby the box is ready for shipment.

7. The method as defined in claim 6, wherein the step of shipping the box further includes placing the box in the second collapsed condition into a standard size mailbag of a mail carrier.

8. The method as defined in claim 7, wherein the step of shipping the collapsed box comprises sending the collapsed box from business premises of the online auction site to the seller through the mail.

9. The method as defined in claim 7, wherein the step of offering a box for sale comprises providing a link on the online auction site that redirects the seller to a packaging provider; and the step of shipping the collapsed box comprises sending the collapsed box from the packaging provider to the seller through the mail.

10. The method as defined in claim 9, further comprising the step of:
applying a shipping label to the box one of:
prior to moving the box into the first collapsed condition,
when the box is in the first collapsed condition; and
when the box is in the second collapsed condition.

11. The method as defined in claim 10, wherein the step of applying the shipping label includes:
selecting a printing location on the box such that the shipping label will not be visible when the box is loaded with the product and is ready to be shipped to the potential buyer.

12. The method as defined in claim 11, wherein the step of applying the shipping label includes printing a mailing address for the seller on one of the top and bottom flaps.

13. The method as defined in claim 12, wherein the step of printing the mailing address includes the steps of:
selecting the mailing address for the seller from a database;
passing the box beneath a print head; and
printing the mailing address onto a surface of the one of the top and bottom flaps that will face outwardly when the box is moved into either of the first and second collapsed conditions.

14. The method as defined in claim 5, wherein the step of providing a collapsed box further includes applying a pre-paid postal decal onto one of the side panels of the box.

15. The method as defined in claim 14, wherein the step of applying the decal includes printing the decal on the one of the side panels in an area to be covered by one of the top and bottom flaps when the box is moved into either of the first and second collapsed conditions.

16. The method as defined in claim 5, wherein the step of providing a collapsed box further includes applying a second mailing label to one of the side panels of the box.

17. The method as defined in claim 16, wherein the step of applying a second mailing label includes printing a plurality of horizontal lines onto the one of the side panels, wherein the lines are configured so as to permit the seller to write in a mailing address of one of the potential buyers thereon.

18. The method as defined in claim 2, wherein the step of shipping the collapsed box comprises shipping a flat-rate box to the seller at a non-flat rate.

19. The method as defined in claim 1, wherein the step of determining the starting bid comprises the steps of:
utilizing a starting price set by the seller as the starting bid.

20. The method as defined in claim 1, wherein the step of determining the starting bid comprises the steps of:
adding a starting price set by the seller to the shipping cost.

21. The method as defined in claim 1, wherein the step of determining the shipping cost comprises the steps of:
adding a first amount of money reflective of the cost for purchasing a selected size of box; and
adding a second amount of money reflective of the cost for shipping the box in a collapsed condition to the seller.

22. The method as defined in claim 21, wherein the step of adding the second amount of money comprises adding a non-flat rate amount of money based on the dimensions of the collapsed box.

23. The method as defined in claim 22, wherein the step of determining the shipping cost further includes the step of
adding a third amount of money reflective of the cost for sending an erected and filled box through the mail.

24. The method as defined in claim 23, wherein the step of adding the third amount of money comprises adding a flat rate amount of money equivalent to one of a plurality of pre-negotiated postal rates based on the size of the collapsed box and a maximum permissible weight of the box when erected and filled.

25. The method as defined in claim 2, further comprising the steps of:
receiving the collapsed box at the seller's mailing address;
moving the collapsed box from the second collapsed condition to an erected condition;
sealing the bottom flaps of the box together;
loading the product into the erected box;
sealing the top flaps of the box together; and
mailing the loaded box to the buyer.

26. The method as defined in claim 25, wherein the step of mailing the loaded box to the buyer includes mailing the box at a flat-rate.

27. The method as defined in claim 2, wherein the step of shipping the collapsed box to the seller includes the steps of:
stacking at least one additional collapsed box one of on top or beneath the collapsed box; and
binding the two stacked boxes together.

28. The method as defined in claim 27, wherein the step of binding the two stacked boxes together includes the steps of:
wrapping a length of retaining tape around the stacked boxes; and
securing the length of retaining tape in place so the boxes do not become disengaged.

29. The method as defined in claim 27, wherein the step of shipping the stack of boxes includes applying the shipping address of the seller onto one of a top and a bottom flap of the outermost one of the stacked collapsed boxes.

30. A method of selling and shipping products utilizing the internet comprising the steps of:
providing an online auction site where a seller is able to create an auction listing offering a product for sale and potential buyers are able to view that auction listing and submit bids for purchase of the product;
offering a plurality of different size boxes for a seller to purchase in order to mail an auctioned product to a potential buyer,
receiving an online listing for a product from a seller including a starting price;
receiving an order for a particular size box from the seller;
determining a starting bid for the product by adding a price for purchasing and shipping the particular size box to a starting price selected by the seller;
posting the auction listing for the product including the starting bid;
receiving a plurality of bids from potential buyers over a predetermined period of time;
determining the highest bid from a plurality of bids after the period of time has elapsed;
contacting the potential buyer with the highest bid to advise them that they have won the auction for the product;
advising the buyer with the highest bid as to how to pay the seller directly; and
shipping the particular size box to the seller in a collapsed condition, where the box has a maximum height that is substantially equal to a height of one of a plurality of side panels as measured between a top and a bottom edge of the panel.

31. The method as defined in claim 30, wherein the step of shipping the particular size box comprises mailing a flat-rate box in a collapsed condition to the seller at a non-flat rate.

32. The method as defined in claim 30, wherein the step of mailing the collapsed box includes collapsing the box to a size suitable for insertion into a standard size mailbag for a mail carrier.

33. The method as defined in claim 30, wherein the step of determining the starting bid price includes the steps of:
adding a first amount of money for the cost of the particular size box;
adding a second amount of money for shipping the particular size box at a non-flat rate to the seller; and
adding a third amount of money for shipping the box from the seller to the potential buyer.

34. The method as defined in claim 33, wherein the step of adding the third amount of money includes selecting a flat rate mailing cost from a list based on the dimensions and maximum allowable weight of the box when erected and filled.

35. A method of selling and shipping products utilizing the internet comprising the steps of:
creating an online listing for a product on an online auction site;
ordering a collapsed flat-rate box from a packaging supplier via an online link on the online auction site;
receiving the collapsed flat-rate box from the packaging supplier;
receiving notification of a winning bid from the online auction site;
receiving payment for the product from a buyer who made the winning bid;
erecting the collapsed box;
loading the product into the erected box;
sealing the loaded box;
placing a mailing address for the buyer on the box; and
sending the loaded flat-rate box to the buyer through the mail for a flat-rate fee.

36. The method as defined in claim 16, wherein the step of applying a second mailing label to one of the side panels of the box includes printing the second mailing label onto the one of the side panels prior to moving the box into either of the first and second collapsed conditions.
